(19) United States
(12) Patent Application Publication
(10) Pub. No.: US 2025/0305896 A1
(43) Pub. Date: Oct. 2, 2025

(54) TORQUE SENSOR SUPPORT STRUCTURE AND ROBOT

(71) Applicant: FANUC CORPORATION, Yamanashi (JP)

(72) Inventors: Qin Chen TAN, Yamanashi (JP); Yasunobu HATADA, Yamanashi (JP)

(73) Assignee: FANUC CORPORATION, Yamanashi (JP)

(21) Appl. No.: 18/863,035

(22) PCT Filed: Aug. 8, 2022
(86) PCT No.: PCT/JP2022/030250

§ 371 Date: Nov. 5, 2024

(51) Int. Cl. G01L 3/10; B25J 13/08

(52) U.S. Cl. CPC G01L 3/108; B25J 13/085

(57) ABSTRACT

A torque sensor support structure. A torque sensor is disposed between a decelerator and a first member for attaching the decelerator, and detects torque acting between the decelerator and the first member. An adaptor is provided to fix the torque sensor to the first member. The adaptor suppresses deformation of the first member due to at least one of moment or force which act on the torque sensor.

### TECHNICAL FIELD

The present disclosure relates to torque sensor support structures and robots.

### BACKGROUND

A known torque sensor in the related art includes at least two sensor units provided between a first structural body and a second structural body coupled to each other by a third structural body. In this torque sensor, the rigidity of one of the first structural body and the second structural body disposed closer toward the sensor units is set to be higher than that of the other (e.g., see Japanese Unexamined Patent Application, Publication No. 2020-12660).

### SUMMARY

An aspect of the present disclosure is a torque sensor support structure including an adaptor that fixes a torque sensor to a first member. The torque sensor is disposed between a decelerator and the first member for attaching the decelerator, and detects torque acting around an axis of the decelerator. The adaptor suppresses deformation of the first member caused by at least one of force or moment acting on the torque sensor.

### BRIEF DESCRIPTION OF DRAWINGS

FIG. 1 is a partial vertical sectional view illustrating a robot according to an embodiment of the present disclosure.

FIG. 2 is a partially enlarged vertical sectional view illustrating a torque sensor support structure in the robot in FIG. 1.

FIG. 3 is an exploded vertical sectional view of a decelerator, a torque sensor, and an O-ring in the robot in FIG. 1.

FIG. 4 is a vertical sectional view illustrating the decelerator, the torque sensor, and the O-ring in FIG. 3 in an assembled state.

FIG. 5 is an exploded vertical sectional view illustrating an adaptor, O-rings, and a base that are to be combined with the assembly unit in FIG. 4.

FIG. 6 is a partially enlarged vertical sectional view illustrating how the torque sensor and the adaptor are combined with each other in the torque sensor support structure in FIG. 2.

FIG. 7 is a partially enlarged vertical sectional view illustrating the start of engagement of the torque sensor with an inlay section of the adaptor in FIG. 6.

FIG. 8 is a partially enlarged vertical sectional view illustrating a state where the engagement between the inlay section of the adaptor in FIG. 6 and the torque sensor is completed.

FIG. 9 is a vertical sectional view illustrating a state where the adaptor, the O-rings, and the base are combined with the assembly unit in FIG. 4.

### DETAILED DESCRIPTION OF EMBODIMENTS

A torque sensor support structure and a robot 1 according to an embodiment of the present disclosure will be described below with reference to the drawings.

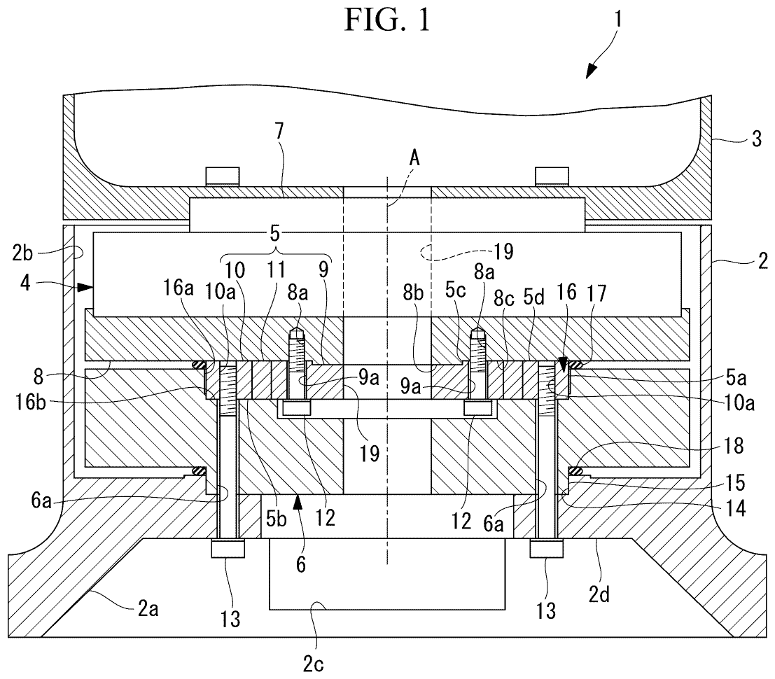

The robot 1 according to this embodiment is, for example, a vertical articulated robot. As shown in FIG. 1, the robot 1 includes a base (first member) 2 fixed to an installation surface, such as a floor surface. The robot 1 includes a rotating body (second member) 3 supported in such a manner as to be rotatable around a first axis A relative to the base 2.

The base 2 and the rotating body 3 are composed of, for example, a lightweight metallic material, such as an aluminum alloy. The base 2 has a tubular shape with openings 2a and 2b opened on both sides thereof in the direction of the first axis A. In a part of a sidewall, the base 2 has another opening 2c for inserting a wiring member, such as a cable, therethrough. The base 2 includes a partition wall 2d for partitioning the internal space thereof in the direction of the first axis A.

A decelerator 4 that rotationally drives the rotating body 3 around the first axis (axis) A relative to the base 2 is disposed between the base 2 and the rotating body 3. A torque sensor 5 and an adaptor 6 are fixed between the decelerator 4 and the partition wall 2d of the base 2. The torque sensor 5 is disposed between the decelerator 4 and the base 2 and detects torque acting around the first axis A between the decelerator 4 and the base 2.

A support structure for the torque sensor 5 according to this embodiment fixes the torque sensor 5 to the base 2 with the adaptor 6 interposed therebetween. The decelerator 4 has a cylindrical shape and is indirectly fixed to the base 2 with the adaptor 6 and the torque sensor 5 interposed therebetween. The decelerator 4 includes an output section 7 directly fixed to the rotating body 3 and a casing 8 indirectly fixed to the base 2.

The torque sensor 5 has a shape of a circular plate with a smaller outer diameter than the decelerator 4. The torque sensor 5 includes a ring-shaped first section 9 disposed radially inward and a ring-shaped second section 10 disposed radially outward. The torque sensor 5 includes a third section 11 that couples the first section 9 and the second section 10 to each other.

In the third section 11, a sensor, such as a strain gauge, not shown, is disposed for detecting torque based on strain. The sensor may be disposed at a position close to either the first section 9 or the second section 10, or may be disposed at an equal distance therefrom.

The first section 9 of the torque sensor 5 is provided with a plurality of through-holes 9a that penetrate in the thickness direction and that are spaced circumferentially. At one end surface 5d of the first section 9, the torque sensor 5 includes a circular recess 5c centered on the first axis A.

On the other hand, the casing 8 of the decelerator 4 includes a protrusion 8b that engages with the recess 5c of the torque sensor 5 and an end surface 8c that is in close contact with the end surface 5d of the torque sensor 5. The protrusion 8b of the casing 8 and the recess 5c of the torque sensor 5 are engaged with each other with an extremely small engagement length of, for example, 1 to 2 mm.

In a state where the protrusion 8b is engaged with the recess 5c and the end surface 8c is in close contact with the end surface 5d, bolts 12 inserted through the through-holes 9a are fastened to screw holes 8a. Accordingly, the torque sensor 5 is fixed to the decelerator 4. The second section 10 of the torque sensor 5 is provided with a plurality of screw holes 10a that penetrate in the thickness direction and that are spaced circumferentially.

The adaptor 6 is composed of a material, such as iron, with higher rigidity than the material used for forming the base 2, and has a shape of a large circular plate at the radially outer side of the torque sensor 5. The adaptor 6 is provided with a plurality of through-holes 6a penetrating in the thickness direction and arranged apart from each other in the circumferential direction around the first axis A. The adaptor 6 is fixed to the torque sensor 5 by fastening bolts 13 extending through the through-holes 6a to the screw holes 10a in the second section 10.

The adaptor 6 has a sufficiently larger outer diameter than the outer diameter of the torque sensor 5. Specifically, the adaptor 6 extends radially outward further beyond an outer peripheral surface 5a of the torque sensor 5. In the example shown in FIG. 1, the outer diameter of the adaptor 6 is equal to the outer diameter of the decelerator 4.

Furthermore, the adaptor 6 has a size that covers the entire torque sensor 5 in the radial direction.

Specifically, the adaptor 6 has a size that is required for fixing and that extends radially inward of the second section 10 of the torque sensor 5. The adaptor 6 also has a thickness sufficiently larger than the thickness of the torque sensor 5. Accordingly, the adaptor 6 ensures sufficient rigidity for suppressing deformation of the base 2.

The adaptor 6 includes a first engagement section 15 constituted of a circular protrusion that engages with a circular recess 14 provided in the base 2 and centered on the first axis A. The adaptor 6 also includes a second engagement section 16 constituted of a circular recess to be engaged with the outer peripheral surface 5a of the torque sensor 5. The outer diameter of the protrusion serving as the first engagement section 15 and the inner diameter of the recess serving as the second engagement section 16 are set to be substantially equal to each other.

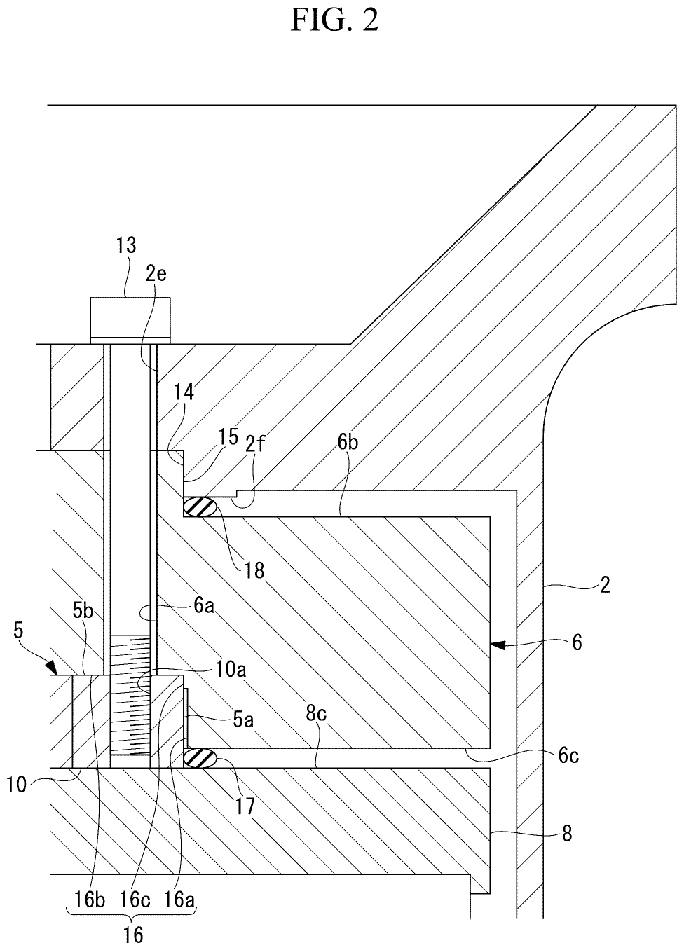

As shown in FIG. 2, the second engagement section 16 includes an inner peripheral surface 16a disposed radially outward of the outer peripheral surface 5a of the torque sensor 5 with a gap therebetween. The second engagement section 16 also includes a bottom surface 16b with which an end surface 5b in the thickness direction of the second section 10 of the torque sensor 5 is brought into abutment.

The second engagement section 16 includes an inlay section 16c that engages with only one end of the outer peripheral surface 5a when the end surface 5b of the torque sensor 5 is brought into abutment with the bottom surface 16b. The engagement length of the inlay section 16c is set to be slightly larger than an appropriate squeeze (compression amount) of an O-ring (seal member) 17, to be described later, but is preferably small as much as possible. For example, if the appropriate squeeze of the O-ring 17 is 0.7 mm, the engagement length of the inlay section 16c is preferably larger than 0.7 mm and smaller than or equal to 2 mm.

The through-holes 6a are provided at positions aligned with the screw holes 10a when the outer peripheral surface 5a of the torque sensor 5 is engaged with the second engagement section 16.

The base 2 is provided with a plurality of through-holes 2e at positions aligned with the through-holes 6a when the first engagement section 15 of the adaptor 6 is engaged with the recess 14.

The bolts 13 extending through the through-holes 2e in the base 2 and the through-holes 6a in the adaptor 6 are fastened to the screw holes 10a in the torque sensor 5. Accordingly, with the joint fastening using the bolts 13, the torque sensor 5 and the adaptor 6 can be fixed to the base 2.

An outer portion of the adaptor 6 at the radially outer side of the torque sensor 5 has parallel end surfaces (flat surfaces) 6b and 6c located at both sides in the thickness direction and orthogonal to the thickness direction. The base 2 has an end surface (flat surface) 2f facing the end surface 6b at the outer portion of the adaptor 6 with a gap therebetween in the direction of the first axis A. The end surface (flat surface) 8c of the casing 8 faces the end surface 6c at the outer portion of the adaptor 6 with a gap therebetween in the direction of the first axis A.

A ring-shaped O-ring 18 surrounding the first engagement section 15 is disposed between the end surface 2f of the base 2 and the end surface 6b of the adaptor 6. Furthermore, the O-ring 17 is disposed between the end surface 8c of the casing 8 of the decelerator 4 and the end surface 6c of the adaptor 6.

The gap between the flat surface 2f of the base 2 and the flat surface 6b of the adaptor 6 has dimensions that allow the O-ring 18 to be compressed with an appropriate squeeze. The gap between the end surface 8c of the casing 8 and the end surface 6c of the adaptor 6 has dimensions that allow the O-ring 17 to be compressed with an appropriate squeeze.

A squeeze is a difference in the wire diameter of each of the O-rings 17 and 18 in the direction of the first axis A between when the O-ring is not compressed and when the O-ring is compressed. By being compressed with the appropriate squeeze, each of the O-rings 17 and 18 hermetically seals the gap to prevent liquid or gas from passing therethrough.

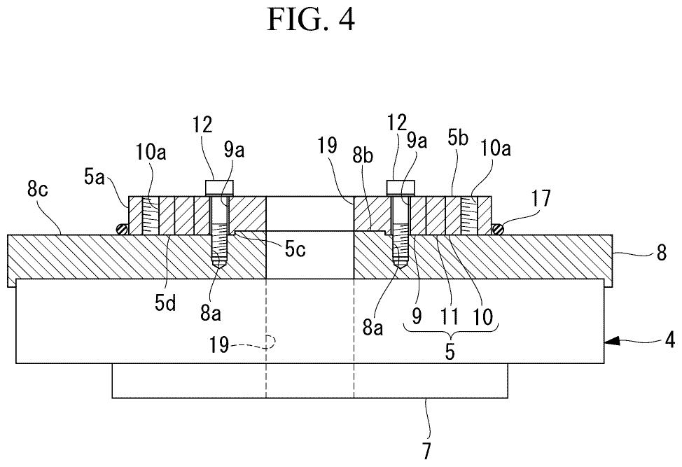

The O-ring 17 has a shape of a ring that surrounds the torque sensor 5. For example, as shown in FIG. 4, when not compressed, the O-ring 17 has an inner diameter larger than or equal to the outer diameter of the outer peripheral surface 5a of the torque sensor 5. As shown in FIG. 2, when compressed, the O-ring 17 has an inner diameter at which the O-ring 17 does not come into contact with or lightly comes into contact with the outer peripheral surface 5a of the torque sensor 5.

Accordingly, the O-ring 17 hermetically seals the gap between the end surfaces 6c and 8c that come into contact with the O-ring 17 from opposite sides in the direction of the first axis A. The O-ring 18 hermetically seals the gap between the end surfaces 2f and 6b that come into contact with the O-ring 18 from opposite sides in the direction of the first axis A.

The base 2, the adaptor 6, the torque sensor 5, and the decelerator 4 include a hollow hole 19 that is provided in the space including the first axis A and through which the base 2 communicates with the interior of the rotating body 3. The wiring member (not shown) inserted through the opening 2c in the base 2 can be routed toward the rotating body 3 via the hollow hole 19.

The operation of the support structure for the torque sensor 5 and the robot 1 according to this embodiment having the above-described configuration will be described below. The robot 1 according to this embodiment is assembled as follows.

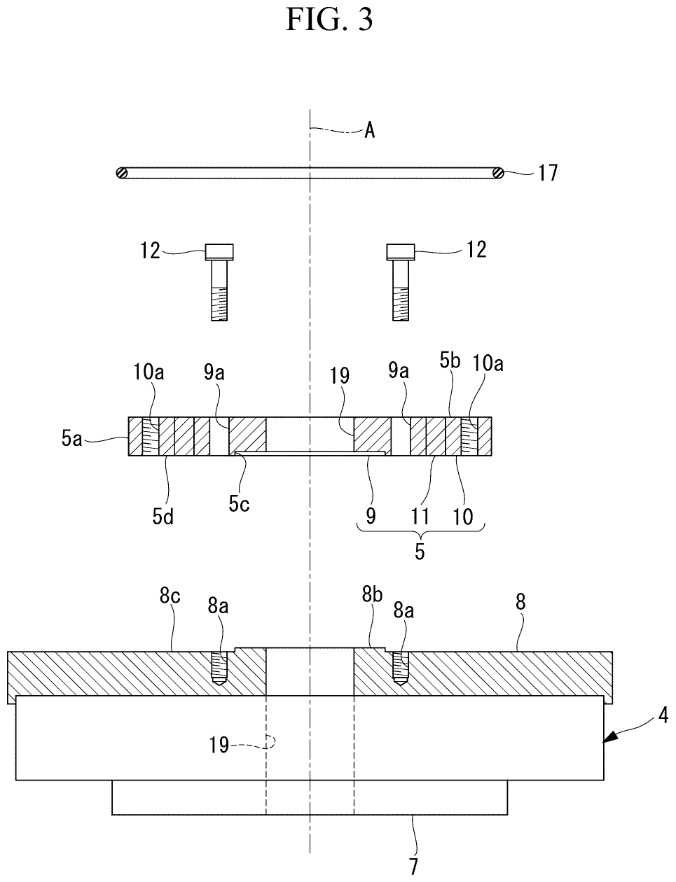

First, as shown in FIG. 3, the decelerator 4 is placed with the casing 8 on the top such that the first axis A extends in the vertical direction. Then, the torque sensor 5 is brought closer toward the decelerator 4 from thereabove. The protrusion 8b of the casing 8 is brought into engagement with the recess 5c of the torque sensor 5, and the end surface 5d of the torque sensor 5 is brought into close contact with the end surface 8c of the casing 8.

In this state, the phase of the through-holes 9a in the first section 9 of the torque sensor 5 is matched with the phase of the screw holes 8a in the casing 8. Then, as shown in FIG. 4, the bolts 12 inserted through the through-holes 9a in the first section 9 of the torque sensor 5 are fastened to the screw holes 8a in the casing 8. Accordingly, the torque sensor 5 is fixed to the casing 8 of the decelerator 4 in a mutually positioned state in the direction of the first axis A and in the direction orthogonal to the first axis A.

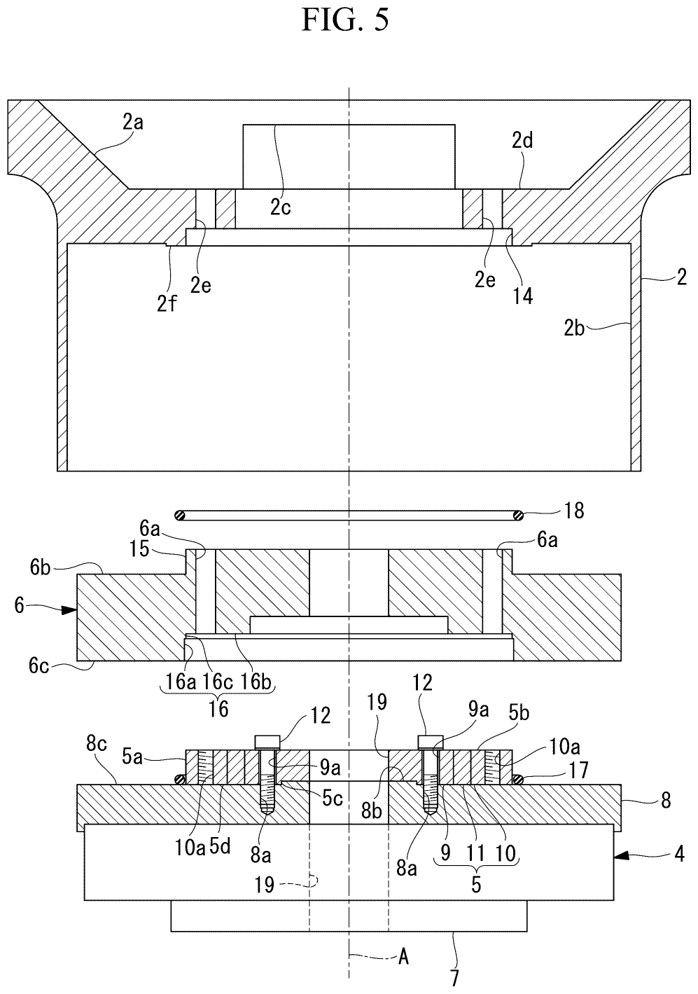

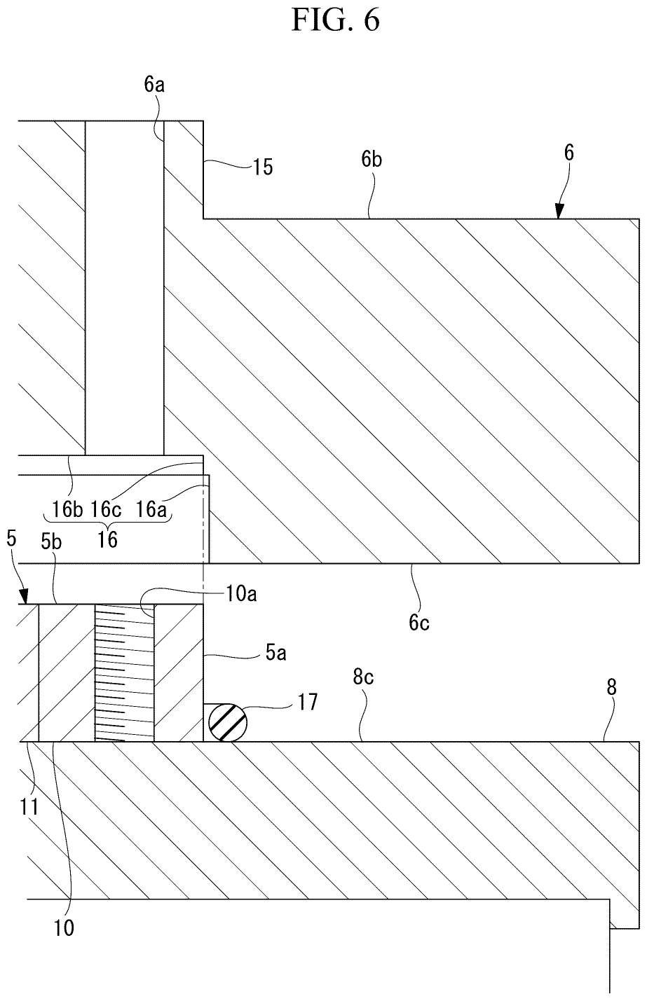

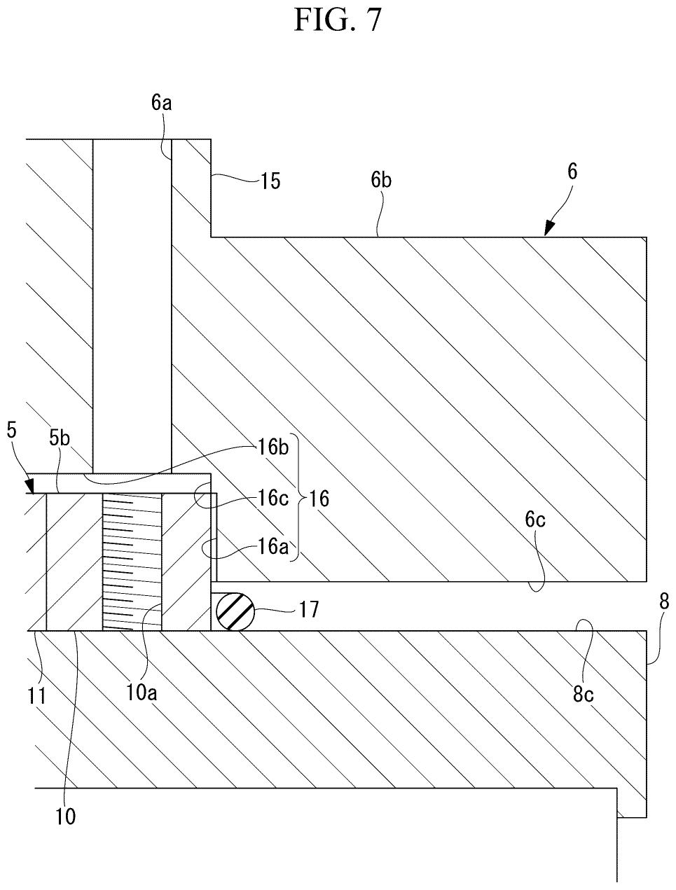

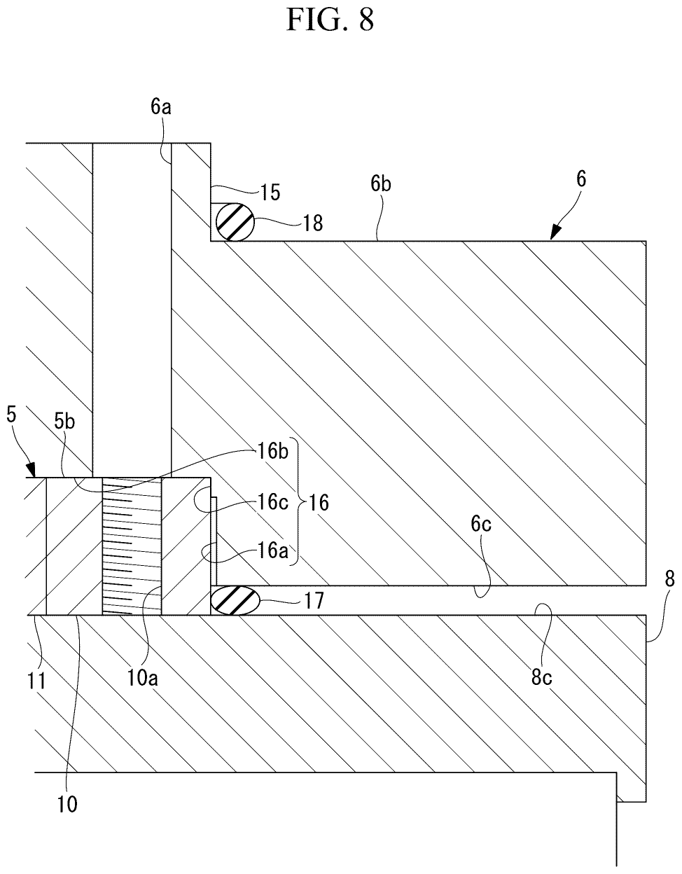

Subsequently, the O-ring 17 is set around the outer periphery of the torque sensor 5 fixed on the decelerator 4, so as to be disposed on the end surface 8c of the casing 8 at the radially outer side of the outer peripheral surface 5a. In this state, as shown in FIG. 5, the adaptor 6 is lowered from above the torque sensor 5. As shown in FIGS. 6 and 7, the torque sensor 5 is inserted into the second engagement section 16 of the adaptor 6. Then, as shown in FIG. 8, the outer peripheral surface 5a of the torque sensor 5 is brought into engagement with the inlay section 16c near the bottom surface 16b of the second engagement section 16.

In this case, according to this embodiment, the engagement length by which the torque sensor 5 is engaged with the inlay section 16c is set to be slightly larger than the appropriate squeeze of the O-ring 17. Therefore, as shown in FIG. 7, the torque sensor 5 starts to engage with the inlay section 16c before the adaptor 6 comes into contact with the O-ring 17.

In a case where the engagement starts after the adaptor 6 comes into contact with the O-ring 17, the operator cannot tactually recognize the start of the engagement, thus lowering the workability of the assembly process. In contrast, with the adaptor 6 coming into contact with the O-ring 17 after the start of the engagement, the operator can recognize the start of the engagement more reliably. Consequently, the workability of the assembly process is enhanced.

As shown in FIG. 8, the outer peripheral surface 5a of the torque sensor 5 is brought into engagement with the inlay section 16c. By bringing the bottom surface 16b of the second engagement section 16 of the adaptor 6 into close contact with the end surface 5b of the torque sensor 5, the O-ring 17 is compressed with the appropriate squeeze. In this state, the phase of the through-holes 6a in the adaptor 6 is matched with the phase of the screw holes 10a in the torque sensor 5.

In this state, the O-ring 18 is disposed on the flat surface 6b at the radially outer side of the first engagement section 15 of the adaptor 6. Then, as shown in FIG. 5, the base 2 in a vertically inverted position is brought closer toward the adaptor 6 from thereabove, and the first engagement section 15 of the adaptor 6 is brought into engagement with the recess 14 of the base 2.

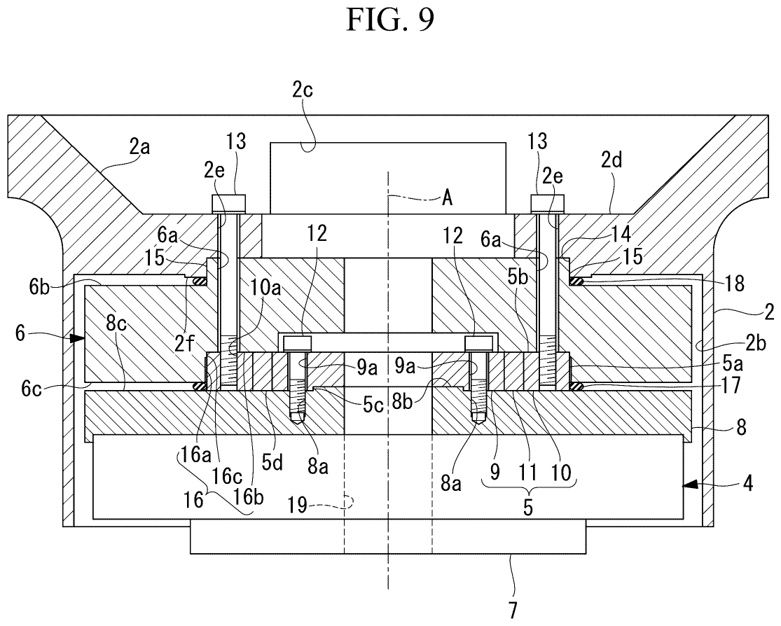

At the time point when the bottom surface of the recess 14 of the base 2 comes into close contact with the end surface of the adaptor 6, the phase of the through-holes 2e in the base 2 is matched with the phase of the through-holes 6a in the adaptor 6. Then, as shown in FIG. 9, the bolts 13 inserted through the through-holes 2e and 6a in the base 2 and the adaptor 6 are fastened to the screw holes 10a in the torque sensor 5.

By fastening the bolts 13, the torque sensor 5 and the adaptor 6 are fixed by being fastened together to the base 2. Then, the torque sensor 5, the adaptor 6, and the base 2 are fixed in a mutually positioned state in the direction of the first axis A and in the direction orthogonal to the first axis A.

By being fixed in accordance with the joint fastening using the bolts 13, the torque sensor 5 and the adaptor 6, as well as the adaptor 6 and the base 2, can be fixed at an equal distance in the radial direction. As compared with a case where the fixation distance varies in the radial direction, the torque sensor 5 is less likely to be affected by moment occurring around an axis orthogonal to the first axis A.

Also, with the joint fastening, countersunk holes in the adaptor 6 required when fixing the adaptor 6 individually to the torque sensor 5 and the base 2 are not required. Consequently, the rigidity of the adaptor 6 can be prevented from decreasing, and an unnecessary increase in size of the adaptor 6 can be prevented.

When the joint fastening is completed, the dimensions of the gap between the casing 8 and the adaptor 6 and the gap between the base 2 and the adaptor 6 become equal to the amounts by which the O-rings 17 and 18 are compressed by the appropriate squeezes. As a result, the gap between the casing 8 of the decelerator 4 and the adaptor 6 is hermetically sealed along the entire circumference by the O-ring 17 at the radially outer side of the torque sensor 5. The gap between the base 2 and the adaptor 6 is also hermetically sealed along the entire circumference by the O-ring 18 at the radially outer side of the first engagement section 15 of the adaptor 6.

According to this embodiment, the torque sensor 5 is fixed to the base 2 with the adaptor 6 interposed therebetween in this manner. The adaptor 6 is composed of a material with higher rigidity than the base 2. Furthermore, the adaptor 6 is thick and extends wide not only over the second section 10 of the torque sensor 5 to be fixed thereto but also over the radially inner and outer sides thereof.

Accordingly, the adaptor 6 has sufficiently high rigidity and can sufficiently suppress deformation of the base 2 at the bottom surface of the recess 14 to which the adaptor 6 is fixed. Specifically, deformation of the base 2 caused by force or torque applied to the torque sensor 5 from the decelerator 4 can be suppressed, so that the detection accuracy of the torque sensor 5 can be enhanced.

Furthermore, according to this embodiment, the engagement between the outer peripheral surface 5a of the torque sensor 5 and the adaptor 6 is achieved in accordance with the inlay section 16c having a sufficiently small engagement length. By engaging the outer peripheral surface 5a of the torque sensor 5 with the inlay section 16c, the center of the torque sensor 5 and the center of the adaptor 6 can be accurately aligned with each other.

With the reduced engagement length of the inlay section 16c, the effect of force or moment acting on the outer peripheral surface 5a of the torque sensor 5 from the adaptor 6 can be prevented. Specifically, it is possible to prevent force or moment acting on the outer peripheral surface 5a of the torque sensor 5 from being detected as torque by the torque sensor 5. Consequently, a decrease in the detection accuracy of torque by the torque sensor 5 can be prevented.

Furthermore, the gap between the casing 8 of the decelerator 4 and the adaptor 6 is hermetically sealed by the O-ring 17 at the radially outer side of the torque sensor 5. Consequently, liquid entering from the outside through a gap between the base 2 and the rotating body 3 can be prevented from entering the torque sensor 5.

The gap between the adaptor 6 and the base 2 is also hermetically sealed by the O-ring 18. Consequently, liquid entering from the outside through the gap between the base 2 and the rotating body 3 can be prevented from entering radially inward of the adaptor 6.

As a method for preventing liquid from entering through the gap between the base 2 and the rotating body 3, there is a method of hermetically sealing a cylindrical gap between the decelerator 4 and the base 2. This method involves the use of only one O-ring.

In this case, however, the process of engaging the adaptor 6 with the base 2 is affected by the sliding resistance of the O-ring compressed between the decelerator 4 and the base 2. This sometimes makes it difficult for the operator to tactually recognize the start of the engagement. Fastening the bolts 13 while the engagement is not properly performed may be problematic in terms of damages to the engagement surfaces or a tilted assembled state.

According to this embodiment, the O-ring 17 is compressed between the flat surfaces 6c and 8c orthogonal to the first axis A. Accordingly, the process of engaging the first engagement section 15 of the adaptor 6 with the recess 14 of the base 2 is not affected by the sliding resistance of the O-ring 17. Therefore, the operator can readily and tactually recognize the start of the engagement, thereby enabling a proper assembly process.

In this embodiment, the O-ring 17 is squeezed at the radially outer side of the torque sensor 5 by being compressed in the direction of the axis A between the casing 8 and the adaptor 6. The compressed O-ring 17 does not come into contact with or lightly comes into contact with the outer peripheral surface 5a of the torque sensor 5.

Therefore, the force or moment acting via the O-ring 17 does not act on the torque sensor 5. Consequently, it is possible to prevent force or moment acting on the torque sensor 5 via the O-ring 17 from being detected as torque by the torque sensor 5.

In this embodiment, the O-ring 17 is disposed by using the outer peripheral surface 5a of the torque sensor 5 as a guide. Accordingly, the surface of the casing 8 of the decelerator 4 and the surface of the adaptor 6 for compressing the O-ring 17 may be simple flat surfaces 8c and 6c. This facilitates the machining of the casing 8 and the adaptor 6.

Likewise, the O-ring 18 is disposed by using the first engagement section 15 constituted of the protrusion of the adaptor 6 as a guide. Accordingly, the surfaces of the base 2 and the adaptor 6 for compressing the O-ring 18 may be simple flat surfaces 2f and 6b. This facilitates the machining of the base 2 and the adaptor 6.

In this embodiment, a vertical articulated robot is described as an example of the robot 1. Alternatively, the robot 1 may be of another arbitrary type.

Moreover, in this embodiment, the support structure for the torque sensor 5 provided between the base 2 and the rotating body 3 is described as an example. Alternatively, a similar structure may be employed as a support structure for a torque sensor disposed between a decelerator and a first member for another joint shaft.

In this embodiment described above, the torque sensor 5 is fixed between the casing 8 of the decelerator 4 and the base 2. Alternatively, the embodiment may be applied to a case where the torque sensor 5 is fixed between the output section 7 of the decelerator 4 and the rotating body 3.

In this embodiment, the base 2, the adaptor 6, and the torque sensor 5 are jointly fastened so as to be fixed at an equal distance around the first axis A. Alternatively, the base 2 and the adaptor 6 may be fixed by using a first bolt, and the adaptor 6 and the torque sensor 5 may be fixed by using a second bolt. In this case, the first bolt and the second bolt may be arranged at a pitch in the circumferential direction at an equal distance around the first axis A.

By separating the fixation between the base 2 and the adaptor 6 from the fixation between the adaptor 6 and the torque sensor 5, the adaptor 6 and the torque sensor 5 can be fixed to each other in advance. Accordingly, the torque sensor 5 and the adaptor 6 can be managed as a unit.

The base 2 and the adaptor 6 may be fixed at the radially outer side of the torque sensor 5. In this case, the bolts 13 can be increased in size, and the number of bolts 13 can be reduced.

Although the O-rings 17 and 18 are employed as seal members, seal members of another arbitrary type, such as ring-shaped gaskets, may be employed as an alternative.

Furthermore, in this embodiment, the O-rings 17 and 18 are positionally guided in the radial direction roughly by the outer peripheral surface 5a or the first engagement section 15 at the inner side. Alternatively, O-ring grooves may be formed in the adaptor 6, the casing 8, or the base 2 to define the positions of the O-rings 17 and 18 in the radial direction.

In this embodiment, the sidewall of the base 2 is provided with the opening 2c. Since the opening 2c in the sidewall has a large effect on deformation of the base 2, the opening 2c desirably has small dimensions and the number of openings 2c is desirably small.

The present disclosure is advantageous in that torque acting on the base 2 from the decelerator 4 can be detected accurately even when the base 2 serving as a first member for fixing the decelerator 4 has low rigidity.

Moreover, the robot 1 according to the present disclosure can perform force control accurately in accordance with the support structure for the torque sensor 5 that can accurately detect torque.

Although the embodiments of the present disclosure have been described in detail, the present disclosure is not to be limited to the individual embodiments described above. With regard to these embodiments, various additions, replacements, alterations, partial deletions, and so on are possible so long as they do not depart from the gist of the invention or they do not depart from the concept and spirit of the present invention derived from the contents described in the claims and the equivalents thereof. For example, in the above embodiments, the order of operations may be changed, the order of processes may be changed, some of the operations may be omitted or added in accordance with conditions, and some of the processes may be omitted or added in accordance with conditions, without being limited to the above example. The same applies to a case where a numerical value or a numerical expression is used in the description of the above embodiments.

1. A torque sensor support structure comprising: an adaptor that fixes a torque sensor to a first member, the torque sensor being disposed between a decelerator and the first member for attaching the decelerator, and the torque sensor detecting torque acting around an axis of the decelerator,
wherein the adaptor suppresses deformation of the first member caused by at least one of force or moment acting on the torque sensor.

2. The torque sensor support structure according to claim 1, wherein the adaptor is composed of a material with higher rigidity than the first member.

3. The torque sensor support structure according to claim 1, wherein the torque sensor is fixed to the decelerator, and the adaptor and the first member are fastened to the torque sensor in accordance with joint fastening of a bolt.

4. The torque sensor support structure according to claim 1, wherein the torque sensor is fastened to the decelerator by using a bolt, the first member is fastened to the adaptor by using a first bolt, and the adaptor is fastened to the torque sensor by using a second bolt.

5. The torque sensor support structure according to any one of claims 1,
wherein the torque sensor has a shape of a circular plate, and
wherein the adaptor has a shape of a plate that is larger toward a radially outer side than the torque sensor.

6. The torque sensor support structure according to claim 5, further comprising:
a ring-shaped seal member that surrounds the torque sensor,
wherein the seal member is compressed in a direction of the axis between the decelerator and the adaptor.

7. The torque sensor support structure according to claim 6,
wherein the torque sensor and the adaptor are engaged with each other by means of an inlay section, and
wherein an engagement length of the inlay section is slightly larger than an appropriate compression amount of the seal member.

8. A robot comprising:
a first member;
a second member;
a decelerator that supports the second member so as to be rotatable around a predetermined axis relative to the first member;
a torque sensor that is disposed between the decelerator and the first member and that detects torque acting between the decelerator and the first member, and
an adaptor fixed between the torque sensor and the first member,
wherein the adaptor suppresses deformation of the first member caused by at least one of force or moment acting on the torque sensor.
